(19) United States
(12) Patent Application Publication
(10) Pub. No.: US 2017/0253816 A1
(43) Pub. Date: Sep. 7, 2017

(54) METHOD FOR RECOVERING ALKALI METAL FROM HYDROCARBON FEEDSTOCKS TREATED WITH ALKALI METAL

(71) Applicant: Ceramatec, Inc., Salt Lake City, UT (US)

(72) Inventors: John Howard Gordon, Salt Lake City, UT (US); Jeffrey Dean Killpack, Sandy, UT (US)

(21) Appl. No.: 15/446,299

(22) Filed: Mar. 1, 2017

Related U.S. Application Data
(60) Provisional application No. 62/303,231, filed on Mar. 3, 2016.

(51) Int. Cl. C10G 67/02; C01B 17/30; C01D 1/04; C01B 17/32

(52) U.S. Cl. CPC C10G 67/02; C01B 17/32; C01B 17/30; C01D 1/04; C10G 2300/202; C10G 2300/205

(57) ABSTRACT

A method for removing alkali metal from a hydrocarbon feedstock comprising alkali metal, non-alkali metal and sulfur. The method includes separating out at least a portion of any alkali metal sulfide and a portion of any non-alkali metal from the hydrocarbon feedstock. Hydrogen sulfide can be added to the remaining hydrocarbon feedstock to form alkali hydrosulfide from any alkali metal remaining in the hydrocarbon feedstock. The alkali hydrosulfide is then separated from the hydrocarbon feedstock. Alkali metal may be removed from the alkali metal sulfide separated out from the hydrocarbon feedstock. Alkali hydrosulfide may be treated to form alkali metal sulfide, and alkali metal may also be removed from the formed alkali metal sulfide.

### CROSS-REFERENCE TO RELATED APPLICATIONS

This application claims priority to U.S. Provisional Application No. 62/303,231, filed Mar. 3, 2016 and is expressly incorporated herein by reference.

### FIELD OF THE INVENTION

The present invention relates to the recovery of alkali metal from a hydrocarbon feedstock. More particularly, the invention relates to a method for recovering alkali metal from a hydrocarbon feedstock that contains alkali metal sulfide due to the addition of alkali metal to the hydrocarbon feedstock to help reduce the sulfur content of the hydrocarbon feedstock, and wherein the hydrocarbon feedstock includes non-alkali metals such as heavy metals.

### BACKGROUND OF THE INVENTION

The demand for energy and the hydrocarbons from which that energy is derived is continually rising. New hydrocarbon feedstocks are being looked at to meet this increased energy demand. The new hydrocarbon feedstocks may include shale oil, bitumen, heavy oils, used oils, and the like. The problem with many of these hydrocarbon feedstocks, however is that they contain sulfur, metals, and other materials that hinder their usage. For example, sulfur can cause air pollution, and can poison catalysts designed to remove hydrocarbons and nitrogen oxide from motor vehicle exhaust. Similarly, other metals contained in the hydrocarbon stream can poison catalysts typically utilized for removal of sulfur through standard and improved hydro-desulfurization processes whereby hydrogen reacts under extreme conditions to break down the sulfur bearing organo-sulfur molecules. Shale oil is also characteristically high in nitrogen, sulfur, and heavy metals which makes subsequent hydrotreating difficult. Heavy metals contained in shale oil pose a large problem to upgraders. Sulfur and nitrogen typically are removed through treating with hydrogen at elevated temperature and pressure over catalysts such as Co—Mo/Al₂O₃ or Ni—Mo/Al₂O₃. In many cases, these catalysts become deactivated because the presence of the heavy metals masks the catalysts, rendering them ineffective.

The removal of sulfur, metals and unwanted materials from these hydrocarbon feedstocks is difficult. For example, removal of a sufficient amount of sulfur from bitumen to make the bitumen useful as an energy resource, requires excessive hydrogen to be introduced to the bitumen under extreme conditions. This increases costs and inefficiencies and makes upgrading bitumen an economically undesirable process.

Over the last several years, alkali metal has been recognized as being effective for the treatment of high-sulfur petroleum oil distillate, crude, heavy oil, bitumen, and shale oil. Alkali metal is capable of reacting with the oil and its contaminants to dramatically reduce the sulfur, nitrogen, and non-alkali metal content through the formation of alkali metal sulfide compounds (sulfide, polysulfide and hydrosulfide). For example, an alkali metal such as sodium or lithium is reacted with the oil at a temperature of about 350° C. and at a pressure ranging from 300-2000 psi. In one non-limiting example, 1-2 moles sodium and 1-1.5 moles hydrogen may be needed per mole sulfur according to the following initial reaction with the alkali metal:

R—S—R′+2Na+H₂—→R—H+R′—H+Na₂S (1)

R,R′,R″—N+3Na+1.5H₂—→R—H+R′—H+R″—H+Na₃N (2)

Where R, R′, R″ represent portions of organic molecules or organic rings.

However, subsequent removal of the alkali metals from the oil is required because the alkali metal content is not allowed in most product applications. Additionally, most downstream refining processes are also sensitive to the presence of alkali metals. Attempts to remove the alkali metal content with water or steam washes is often very ineffective because of the formation of emulsions which are very challenging to break, even with electrostatic emulsion breakers. The alkali metal may be removed by reacting the alkali metal sulfide and alkali metal nitride products of the foregoing reactions with hydrogen sulfide. However, there is a disadvantage of using hydrogen sulfide to recover alkali metals from the hydrocarbon feedstocks. The hydrogen sulfide can react with the heavy metals or other non-alkali metals in the hydrocarbon feedstock. For example, hydrogen sulfide can react with nickel metal to form nickel sulfide and hydrogen. The nickel sulfide dissolves in the anolyte of the electrolytic cell used to remove the alkali metal and fouls the electrolytic cell membranes preventing the recovery of the alkali metal. Nickel cations along with other metal ions other than alkali metal cations will be attracted toward the membrane due to the potential gradient of the cell but because of the specificity of the membrane, they will not be able to pass through. Instead, they will cling to the membrane surface, blocking the pathway. Thus, adding hydrogen sulfide to the hydrocarbon feedstock containing alkali metal sulfide and non-alkali metals can be inefficient as fouled membranes need to be replaced.

Thus a method is needed which can remove alkali metal content from hydrocarbon feedstocks which have been treated with alkali metal for the purpose of desulfurization, demetallization, and the like, where the alkali metal removal process does not foul membranes in the electrochemical regeneration of the alkali metals.

### BRIEF SUMMARY OF THE INVENTION

The present embodiments include a method of upgrading a hydrocarbon feedstock and recovering alkali metal used during the upgrading process. The hydrocarbon feedstock may include any number of hydrocarbon sources, including petroleum distillates, residues, or other petroleum products, shale oil, bitumen, heavy oil, and the like. These hydrocarbon feedstocks may contain high levels of nitrogen, sulfur, and heavy metals which need to be removed or reduced before the hydrocarbon feedstock can be further treated to make a more consumer friendly or commercial product.

In one embodiment, a method of upgrading a hydrocarbon feedstock includes feeding a hydrocarbon feedstock comprising sulfur and non-alkali metals into a reactor. The hydrocarbon feedstock may also contain nitrogen. The non-alkali metals may include any number of metals, including heavy metals. A radical capping substance is also fed into the reactor. The radical capping substance may include hydrogen, or compounds that may react with the contents in the reactor to form hydrogen. Alkali metal is also fed into the reactor. The alkali metal may include sodium, lithium, sodium alloys, lithium alloys and mixtures thereof. In one embodiment, the reactor is heated to between about 150° C. and about 400° C., inclusive. The reactor may be pressurized to a range of about 500-2000 psi, inclusive.

The non-alkali metals contained in organometallic molecules such as complex porphyrins are reduced to the metallic state by the alkali metal. The alkali metal also reacts with the sulfur in the hydrocarbon feedstock to form alkali metal sulfide. As used herein throughout, the terms “alkali metal sulfide” and “alkali metal sulfides” includes both mono- and poly-sulfides. The radical capping substance reacts with the carbon and hydrogen content to form a hydrocarbon phase in the hydrocarbon feedstock. Inorganic products are formed by the reaction of the alkali metal with non-alkali metal such as heavy metals, sulfur or nitrogen.

The upgrading method also includes a subset method of for removing alkali metal from a hydrocarbon feedstock that has already been treated with alkali metal and now comprising alkali metal sulfide and non-alkali metal. The non-alkali metal may be in the form of compounds, ions, and the like.

The method of upgrading a hydrocarbon feedstock, including the subset method of removing alkali metal from a hydrocarbon feedstock comprising alkali metal sulfide and non-alkali metal, includes the step of separating out at least a portion of any alkali metal sulfide and a portion of any non-alkali metal from the hydrocarbon feedstock. In one embodiment, a substantial portion of alkali metal sulfide and non-alkali metal is separating out from the hydrocarbon feedstock. As used herein throughout, a “substantial portion” of alkali metal sulfide may be greater than 60% of the alkali metal sulfide and a “substantial portion” of non-alkali metal may be greater than 60% of the non-alkali metal. In one embodiment, more than 90% of the alkali metal sulfide and more than 98% of the non-alkali metal are removed in this step.

The upgrading and alkali metal recovery methods include adding at least one of H₂S and H₂O to the remaining hydrocarbon feedstock. With the non-alkali metal substantially removed, the addition of H₂S and H₂O more readily reacts with any remaining alkali metal in the hydrocarbon feedstock. The alkali metal may be in the form of elemental alkali metal, alkali metal ions, alkali metal salts, alkali metal compounds, mixtures thereof, and the like. This reaction causes the formation of at least one of MHS and MOH (wherein M is an alkali metal) to form in the hydrocarbon feedstock. When H₂S is added, MHS is formed and when H₂O is added, MOH is formed.

The method of upgrading a hydrocarbon feedstock, and the method of recovering alkali metal from a hydrocarbon feedstock containing alkali metal sulfide includes the step of separating out the MHS and/or MOH from the hydrocarbon feedstock. In one embodiment, at least one of the MHS and MOH may be treated to form at least one of alkali metal sulfide and hydrogen sulfide (H₂S). The hydrogen sulfide may be used in the step of adding at least one of H₂S and H₂O to the hydrocarbon feedstock after alkali metal sulfide and non-alkali metal have been removed from the feedstock. Alkali metal may be recovered from the alkali metal sulfide formed in this step. Alkali metal is also recovered from the alkali metal sulfide separated out of the hydrocarbon feedstock in the step where at least a portion of any alkali metal sulfide and a portion of any non-alkali metal is removed from the hydrocarbon feedstock.

The present invention provides an efficient method for recovering alkali metal from a hydrocarbon feedstock in spite of the presence of heavy metals in the feedstock. The features and advantages of the present invention will become more fully apparent from the following description and appended claims, or may be learned by practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram showing one embodiment of a method of recovering alkali metal from a hydrocarbon feedstock;

FIG. 2 is a block diagram showing another embodiment of a method of recovering alkali metal from a hydrocarbon feedstock; and

FIG. 3 is a block diagram showing one embodiment of a method of upgrading a hydrocarbon feedstock that includes the method of FIG. 2.

### DETAILED DESCRIPTION OF THE INVENTION

In the following description, specific details of various embodiments are provided. The present invention may be embodied in other specific forms without departing from its spirit or essential characteristics. The described embodiments are to be considered in all respects only as illustrative and not restrictive. While the various aspects of the embodiments are presented in drawings, the drawings are not necessarily drawn to scale unless specifically indicated. The scope of the invention is, therefore, indicated by the appended claims rather than by the foregoing description. All changes which come within the meaning and range of equivalency of the claims are to be embraced within their scope.

Reference throughout this specification to features, advantages, or embodiments does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. The presently described embodiments will be better understood by reference to the drawings, wherein like parts are designated by like numerals throughout.

The present embodiments relate to a method for recovering alkali metal from a hydrocarbon feedstock that includes alkali metal sulfide and non-alkali metal. The alkali metal may include sodium, lithium, sodium alloys, lithium alloys, other alkali metal and metal alloys and combinations thereof. The alkali metal in the hydrocarbon feedstock may have been added previously to facilitate upgrading the hydrocarbon feedstock and to prepare it for further processing. By way of non-limiting example, the original hydrocarbon feedstock may have been heavy oil. In order to upgrade the heavy oil so that it can be flowed or handled and be converted into a useable fuel source, the sulfur must be removed. One way to do this is by adding alkali metal to the hydrocarbon feedstock. The resulting hydrocarbon feedstock may then contain alkali metal sulfide, which can more easily be removed from the hydrocarbon feedstock as a way to reduce the sulfur content. Thus, at one point a hydrocarbon feedstock exists that contains alkali metal sulfide and non-alkali metal. The non-alkali metal in the hydrocarbon feedstock may be heavy metal. Thus, one embodiment of the present invention includes a method for recovering alkali metal from a hydrocarbon feedstock comprising alkali metal sulfide and non-alkali metal. Embodiments of the present invention also include an overall upgrading process, where the hydrocarbon feedstock has not yet been treated with alkali metal. In one embodiment, this upgrading process or method includes all of the steps of the method to recover alkali metal.

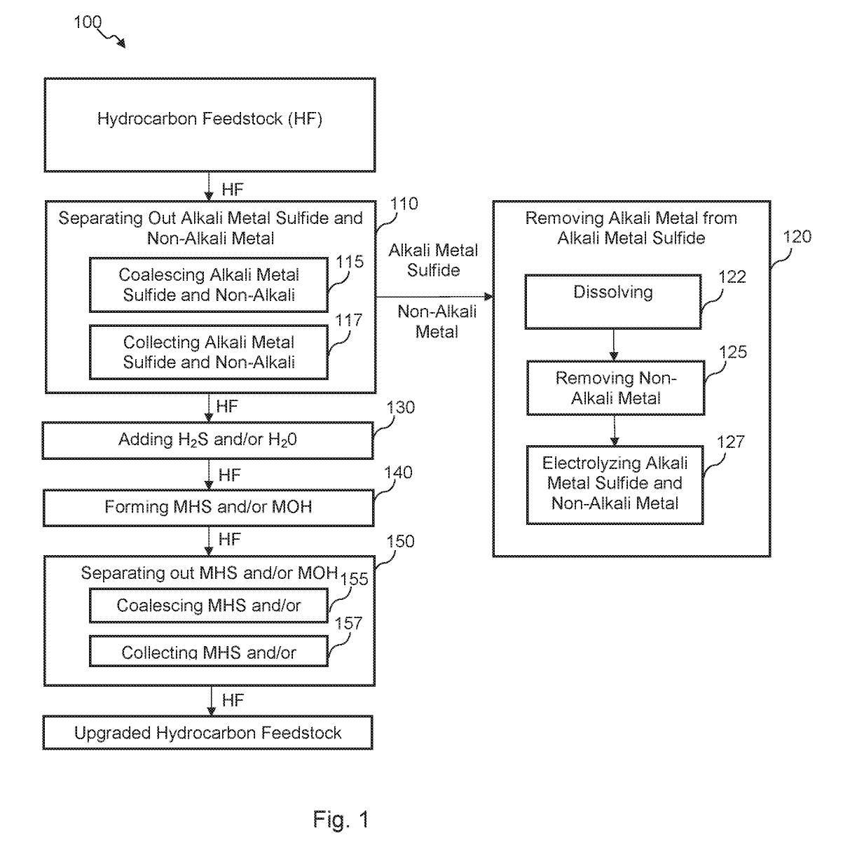

Referring now to FIG. 1, a method 100 for recovering alkali metal from a hydrocarbon feedstock comprising alkali metal sulfide and non-alkali metal includes the step of separating 110 out at least a portion of any alkali metal sulfide and a portion of any non-alkali metal from the hydrocarbon feedstock. As mentioned above, the hydrocarbon feedstock may include any number of hydrocarbon sources, including petroleum distillates, residues, petroleum products, shale oil, bitumen, heavy oil, and the like. The alkali metal sulfide may be in the form of both alkali metal mono- and poly-sulfides. A non-limiting example of a non-alkali metal within the scope of this invention includes Copper, Bismuth, Aluminum, Titanium, Vanadium, Manganese, Chromium, Zinc, Tantalum, Germanium, Lead, Cadmium, Indium, Thallium, Cobalt, Nickel, Iron, Gallium, and the like. Other examples of non-alkali metals within the scope of the present invention may include without limitation metals with a standard reduction potential of 2.7V and below under the following standard conditions: 25° C., a 1 activity for each ion participating in the reaction, a partial pressure of 1 bar for each gas that is part of the reaction, and metals in their pure state.

In one embodiment, a substantial amount of the alkali metal sulfide and non-alkali metal is separated 110 out from the hydrocarbon feedstock. A substantial amount of non-alkali metal is greater than or equal to 60%. A substantial amount of alkali metal sulfide is greater than or equal to 60%. In one embodiment, the step of separating out at least a portion of any alkali metal sulfide and a portion of any non-alkali metal from the hydrocarbon feedstock comprises separating out greater than about 60% of the non-alkali metal from the hydrocarbon feedstock. In another embodiment, 70% of the non-alkali metal may be removed from the hydrocarbon feedstock. In yet another embodiment, 80% of the non-alkali metal may be removed from the hydrocarbon feedstock. In yet another embodiment, 90% of the non-alkali metal may be removed from the hydrocarbon feedstock. In yet another embodiment, 95% of the non-alkali metal may be removed from the hydrocarbon feedstock. In yet another embodiment, 98% of the non-alkali metal may be removed from the hydrocarbon feedstock.

In one embodiment, the step of separating out at least a portion of any alkali metal sulfide and a portion of any non-alkali metal from the hydrocarbon feedstock comprises separating out greater than about 60% of the alkali metal sulfide from the hydrocarbon feedstock. In another embodiment, 70% of the alkali metal sulfide may be removed from the hydrocarbon feedstock. In yet another embodiment, 80% of the alkali metal sulfide may be removed from the hydrocarbon feedstock. In yet another embodiment, 90% of the alkali metal sulfide may be removed from the hydrocarbon feedstock.

The step of separating 110 out at least a portion of any alkali metal sulfide and a portion of any non-alkali metal from the hydrocarbon feedstock may include coalescing 115 at least a portion of any alkali metal sulfide and a portion of any non-alkali metal. In the coalescing 115 step, the alkali metal sulfide and/or non-alkali metal is combined or agglomerated to make it easier to separate from the hydrocarbon feedstock. In one embodiment, coalescing is accomplished by heating the hydrocarbon feedstock comprising the alkali metal sulfide and non-alkali metal. In one embodiment, the hydrocarbon feedstock is heated to a temperature above the alkali metal, making the alkali metal molten. It will be appreciated that sodium metal melts at about 98° C. and lithium metal melts at about 181° C. In another embodiment, the hydrocarbon feedstock is heated to a temperature ranging from 150° C. to 450° C. In yet another embodiment, hydrocarbon feedstock is heated to a temperature ranging from 300° C. to 360° C. The heat allows isolated particles of sodium sulfide to agglomerate sufficiently such that they can be separated. In one embodiment, the hydrocarbon feedstock is heated just enough to create faster reaction kinetics without the occurrence of thermal cracking. The heated hydrocarbon feedstock may be mixed to increase coalescence. In one embodiment the heated hydrocarbon feedstock is mixed for at least 15 minutes.

The coalescing step 115 may also be accomplished by adding elemental sulfur to the hydrocarbon feedstock such that the atomic ratio of alkali metal to sulfur in the hydrocarbon feedstock is less than 0.7. In one embodiment, the atomic ratio of alkali metal to sulfur in the hydrocarbon feedstock is less than 0.65. By heating the hydrocarbon feedstock with the added sulfur to a temperature above the melting point of sulfur, the sulfur becomes molten. When the molten sulfur comes in contact with alkali metal monosulfides, alkali metal polysulfides may form, which have a lower melting point. In one non-limiting example, Na₂S becomes Na₂S₂ after reacting with the additional sulfur, which has a lower melting point than Na₂S. Thus in one embodiment, the hydrocarbon feedstock with the added sulfur need not be heated for as long or heated to a higher temperature. It will be appreciated by those of skill in the art that this will decrease power costs. Coalescing 115 may also be accomplished by mixing the contents of the hydrocarbon feedstock together.

The separating step 110 may be completed by collecting 117 the coalesced alkali metal sulfide and non-alkali metal. The collecting step 117 may include cooling to help form solids. The collecting step 117 may also include centrifuging, filtering, or using other methods to ultimately capture or collect the alkali metal sulfide and non-alkali metal from the hydrocarbon feedstock. The collecting step 117 may be done in a separate step after the after the alkali metal sulfide and non-alkali metal have sufficiently coalesced 115 or may be accomplished as part of a coalescing step 115.

The method 100 includes the step of removing 120 alkali metal from any alkali metal sulfide separated out from the hydrocarbon feedstock. In one embodiment, the step of removing 120 alkali metal from alkali metal sulfide comprises dissolving 122 any alkali metal sulfide and non-alkali metal separated from the hydrocarbon feedstock in a solution. “Dissolving” as used herein includes partial dissolving. In one embodiment, the solution is a polar solvent. In another embodiment, the solution is a non-aqueous polar solvent. The polar solvent may include without limitation, N,N-dimethylaniline, quinoline, tetrahydrofuran, 2-methyl tetrahydrofuran, benzene, cyclohexane, fluorobenzene, trifluorobenzene, toluene, xylene, tetraglyme, diglyme, isopropanol, ethyl propional, dimethyl carbonate, dimethoxy ether, ethanol and ethyl acetate, propylene carbonate, ethylene carbonate, diethyl carbonate, 1,3-Dimethyl-3,4,5,6-tetrahydro-2-pyrimidinone, Methylformide, and 1,3-Dimethyl-2-imidazolidinone (DMI) and the like.

The dissolving step 122 may include adding sulfur and an anolyte to any alkali metal sulfide or non-alkali metal separated from the hydrocarbon feedstock. The dissolving step 122 may be conducted at elevated temperature to increase solubility.

The step of removing 120 alkali metal from alkali metal sulfide includes the step of removing non-alkali metal 125 from the solution of the dissolving step 122. In one embodiment, a substantial amount of non-alkali metal is removed from the solution. The non-alkali metal may be removed by filtration, centrifugation, electro chemistry plating, and the like. As mentioned above, these non-alkali metals include without limitation, heavy metals. The step of removing non-alkali metals may also include removing undissolved solids in the hydrocarbon feedstock such as coke. The removed non-alkali metals may be further processed for other uses or disposed.

The step of removing 120 alkali metal from alkali metal sulfide further includes the step of electrolyzing 127 the solution of step 122, after non-alkali metal has been substantially removed. The electrolyzing step 127 to create alkali metal from the solution. In one embodiment, the electrolyzing step 127 is done in an electrolytic cell. The electrolytic cell may include an anolyte compartment and a catholyte compartment. An anode may be positioned with the anolyte compartment and be in contact with anolyte within the anolyte compartment. The solution from step 122 may be fed into the anolyte compartment.

A cathode may be positioned within the catholyte compartment and be in contact with catholyte in the catholyte compartment. In one embodiment, the catholyte comprises an alkali ion-conductive liquid. A separator is positioned between the anolyte compartment and the catholyte compartment. The separator may be an alkali ion selective membrane such as NaSICON or LiSICON. When a voltage is applied to the electrolytic cell, alkali metal cations M⁺, pass through the separator and reduce to alkali metal in the catholyte. It will be appreciated by those of skill in the art that with the application of certain voltages, sulfide ions dissolved in the anolyte compartment may oxidize and form elemental sulfur. The alkali metal and elemental sulfur may be removed from the electrolytic cell by ways known in the art.

The method 100 includes adding 130 at least one of H₂S and H₂O to the remaining hydrocarbon feedstock after a substantial amount of non-alkali metal has been removed from the hydrocarbon feedstock. With non-alkali metal removed from the hydrocarbon feedstock in step 110, the addition of H₂S to the remaining hydrocarbon feedstock is less likely to oxidize any non-alkali metal. If the non-alkali metal remained in the hydrocarbon feedstock and allowed to oxidize, the oxidized non-alkali metal could easily dissolve in the hydrocarbon feedstock, ultimately fouling membranes such as those used in the electrolyzing step 127 making the ultimate recovery of alkali metal difficult, or at least inefficient and costly. With a substantial amount of alkali metal sulfide and non-alkali metal removed from the hydrocarbon feedstock the H₂S and H₂O is more likely to react with any remaining alkali metal in the hydrocarbon feedstock. This remaining alkali metal may be in the form of elemental alkali metal, alkali metal ions, alkali metal salts, alkali metal compounds, and the like.

The process includes the step of forming 140 at least one of MHS and MOH in the hydrocarbon feedstock. After removing a substantial portion of any non-alkali metal and alkali metal sulfide from the hydrocarbon feedstock and adding one of H₂S and H₂O, the H₂S and/or H₂O react with the remaining alkali metal in the hydrocarbon feedstock. Where H₂S is added, the forming 140 reaction may occur according to at least one of the following formulas:

M+H₂S→MHS+½H₂ (1)

M⁺+H₂S→MHS+H⁺ (2)

M-salt+H₂S→MHS+H-salt (3), and

MNH₂+H₂S→MHS+NH₃ (4),

wherein M represents an alkali metal, M⁺ represents an alkali metal ion, M-salt represents an alkali metal salt, and H-salt represents the corresponding acid of the alkali metal salt M-salt.

Where H₂O is added to the hydrocarbon feedstock, the forming 140 reaction may occur according to at least one of the following formulas:

M+H₂O→NaOH+½H₂ (5)

M⁺+H₂O→NaOH+H⁺ (6)

M-salt+H₂O→MOH+H-salt (7), and

MNH₂+H₂O→MOH+NH₃ (8),

wherein M represents an alkali metal, M⁺ represents an alkali metal ion, M-salt represents an alkali metal salt and H-salt represents the corresponding acid of the alkali metal salt M-salt.

In one embodiment where the alkali metal is sodium, the H₂S reacts with sodium metal in the hydrocarbon feedstock to form NaHS. The sodium may be in the form of metallic sodium, sodium ions, sodium salts, sodium compounds, mixtures thereof, and the like. Lithium, in similar forms, may also be used as the alkali metal and may be combined with H₂S to form LiHS. By way of non-limiting example using sodium and sodium napthanate, NaHS may be formed according to at least one of the following formulas:

Na+H₂S→NaHS+½H₂ (9)

Na⁺+H₂S→NaHS+H⁺ (10)

Na-napthanate+H₂S→NaHS+H-napthanate (11), and

NaNH₂+H₂S→NaHS+NH₃ (12).

It will be appreciated that Na-napthante is a sodium salt and is representative of any number of sodium salts that may be found in the remaining hydrocarbon feedstock. H-napthanate represents the corresponding acid of the sodium salt reactant. In this particular non-limiting example, NaHS and napthanic acid are formed in formula (11). It will be appreciated by those of skill in the art that other sodium salts may react forming NaHS and other corresponding acids.

In another embodiment, H₂O is added to the hydrocarbon feedstock after a substantial portion of any alkali metal sulfide and a substantial portion of any non-alkali metal has been removed from the hydrocarbon feedstock. In one non-limiting example where sodium is used as the alkali metal during upgrading, or where sodium appears in the hydrocarbon feedstock, NaOH is formed according to at least one of the following formulas:

Na+H₂O→NaOH+½H₂ (13)

Na⁺+H₂O→NaOH+H⁺ (14)

Na-napthanate+H₂O→NaOH+H-napthanate (15), and

NaNH₂+H₂O→NaOH+NH₃ (16).

As mentioned above, Na-napthanate represents a sodium salt and H-napthanate represent the corresponding acid. It will be appreciated by those of skill in the art that other salts may be present in the hydrocarbon feedstock and the reactions will produce NaOH and the corresponding acid of the other sodium salt. The formation of MOH and MHS in the forming step 140 also contemplates reactions using lithium in its many forms, including Li, Li⁺, Li-salts, LiNH₂ and the like.

When adding H₂O 130 to the remaining hydrocarbon feedstock in order to form MOH from the alkali metal remaining in the hydrocarbon feedstock, if more H₂O is added than is needed to react with the alkali metal, a step of removing excess water may be added to the process 100.

In one embodiment, the forming 140 of MHS and/or MOH includes mixing 145 the at least one of H₂S and H₂O with the hydrocarbon feedstock remaining after alkali metal sulfide and non-alkali metal has been removed. The mixing 145 may be done in any number of ways, including using an impeller, a bubble column, or any other way that provide contact between the H₂S and/or H₂O and the hydrocarbon feedstock. The forming step 140 may also include pressurizing (not shown) the remaining hydrocarbon feedstock and the added H₂S and/or H₂O to at least 100 psi to enhance the formation of the MOH and/or MHS. In another embodiment, the step of forming 140 at least one of MHS and MOH may include heating the hydrocarbon feedstock and added H₂S and/or H₂O. In another embodiment, the forming 140 at least one of MHS and MOH is done at ambient temperature.

The method 100 includes the step of separating 150 out at least one of MOH and MHS from the hydrocarbon feedstock. In one embodiment, the step of separating 150 out at least one of MOH and MHS from the hydrocarbon feedstock includes coalescing 155 the MOH and/or MHS such that the MOH and/or MHS is combined or agglomerated to make it easier to separate it from the hydrocarbon feedstock. In one embodiment, coalescing 155 is accomplished by heating the at least one of MOH and MHS to at least the melting point of one of the MOH and MHS. In another embodiment, coalescing 155 is accomplished by heating the at least one of MOH and MHS to the greater of the melting point of MOH and the melting point of MHS. By way of non-limiting example using sodium, when NaOH, or the hydrocarbon feedstock contain NaOH is heated to at least 318° C., NaOH becomes molten and it is easier to combine the NaOH together, even if the NaOH is in the form of fine particles suspended in the hydrocarbon feedstock. Similarly, when NaHS in the hydrocarbon feedstock is heated, the NaHS becomes molten and coalescing 145 the NaHS can be more easily accomplished. Mixing of the hydrocarbon feedstock and liquid NaHS can facilitate the coalescing 155 of NaHS droplets.

In one embodiment, the step of separating out at least one of MHS and MOH 150 includes the step of collecting 157 coalesced MHS and/or MOH. Collecting may be accomplished in a number of ways, including cooling the at least one of MOH and MHS to form at least one of a MOH or MHS in solid form. The collecting step 157 may include centrifuging, filtering, or using other methods to ultimately capture or collect the MHS and/or MOH from the hydrocarbon feedstock. The collecting step 157 may be done in a separate step after the after the MHS and/or MOH have sufficiently coalesced 155 or may be accomplished as part of the coalescing step 155. With the separating out 150 of the MHS and/or MOH, the hydrocarbon feedstock is now substantially devoid of heavy metal and sulfur and most of the alkali metal has been recovered. Accordingly, the hydrocarbon feedstock may be considered upgraded.

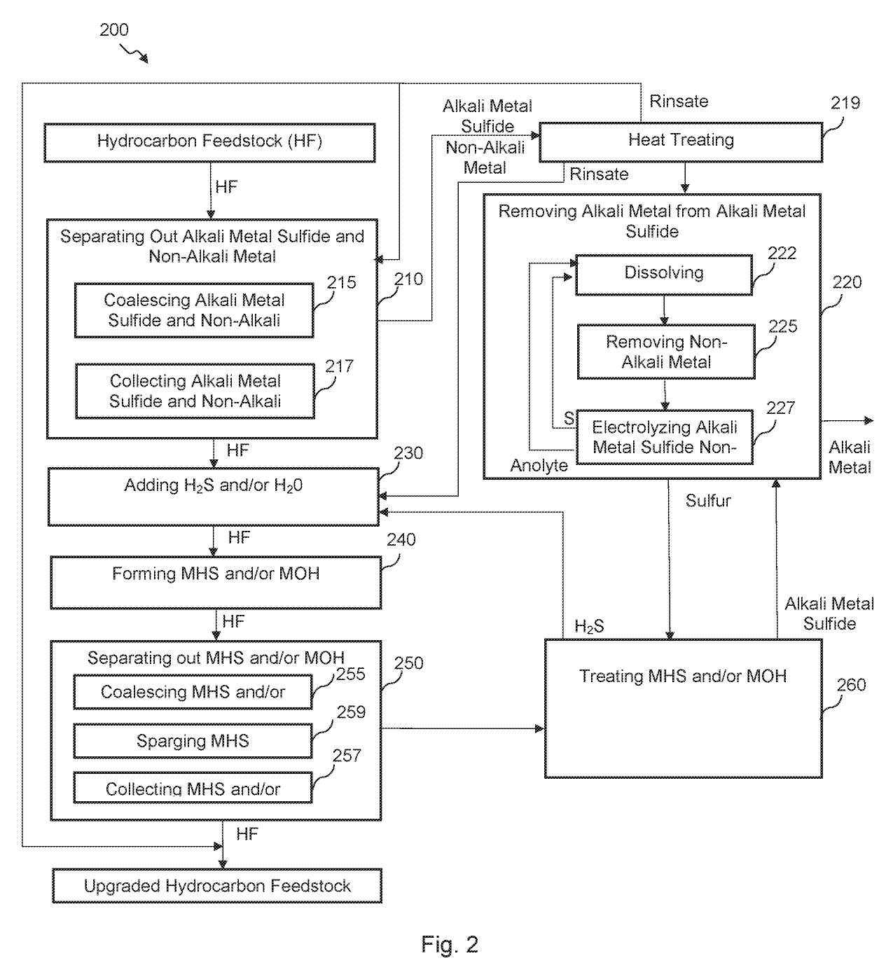

Referring now to FIG. 2, another embodiment of a method 200 for removing alkali metal from a hydrocarbon feedstock comprising alkali metal sulfide and non-alkali metal includes the step of separating 210 out at least a portion of any alkali metal sulfide and a portion of any non-alkali metal from the hydrocarbon feedstock. As mentioned above, the hydrocarbon feedstock may include any number of hydrocarbon sources, including petroleum distillates, residues, or other petroleum products, shale oil, bitumen, heavy oil, and the like. The alkali metal sulfide may be in the form of both alkali metal mono- and poly-sulfides. By way of non-limiting example, the non-alkali metal may include Copper, Bismuth, Aluminum, Titanium, Vanadium, Manganese, Chromium, Zinc, Tantalum, Germanium, Lead, Cadmium, Indium, Thallium, Cobalt, Nickel, Iron, Gallium and the like. As mentioned above, non-alkali metals within the scope of this invention may also include all metals with a standard reduction potential of 2.7V and below under the following standard conditions: 25° C., a 1 activity for each ion participating in the reaction, a partial pressure of 1 bar for each gas that is part of the reaction, and metals in their pure state.

The method 200 includes the step of separating out 210 alkali metal sulfide and non-alkali metal. The step of separating out 210 alkali metal sulfide and non-alkali metal includes the steps of coalescing 215 alkali metal sulfide and non-alkali metal and collecting 217 alkali metal sulfide and non-alkali metal, which is accomplished as described above in connection with steps 110, 115, and 117 and FIG. 1 above.

In one embodiment, the method 200 includes the step of heat treating 219 the alkali metal sulfide and non-alkali metal separated out from the hydrocarbon feedstock in step 210. In the heat treatment step 219, the alkali metal sulfide and non-alkali metal are heated in an non-oxidizing atmosphere where organic gases are released, as well as condensable hydrocarbons (CHs) which may be returned back to the process as a rinsate in steps 210 and/or 220 or combined with the upgraded hydrocarbon feedstock. The alkali metal sulfide and non-alkali metal collected in the collecting step 217 may be rinsed with a light oil to recover adhered oil or the condensable hydrocarbons from step 219. The resulting rinsate may be added back into the process for reuse as a rinse or may be handled separately. The heating process may use the process set forth in U.S. Pat. No. 8,747,660, which is expressly incorporated herein by reference.

The method 200 includes the step of removing 220 alkali metal from alkali metal sulfide, including the steps of dissolving 222, removing non-alkali metal 225, and electrolyzing alkali metal sulfide, which is accomplished as described in connection with steps 120, 125, and 127 in FIG. 1 above. The removing step 220 may be done after the heat treating step 219, or the heating step 219 may be done as part of, or simultaneous with, the removing step 220. In one embodiment, the sulfur added as part of the dissolving step 222 may come from the sulfur generated as part of the electrolyzing step 227. Similarly, the anolyte added as part of the dissolving step may come from the electrolyzing step, after the alkali metal and sulfur have been removed as part of the electrolysis.

The method 200 includes the step 230 of adding at least one of H₂S and H₂O to the remaining hydrocarbon feedstock. As mentioned above, with non-alkali metal removed from the hydrocarbon feedstock in step 210, the addition of H₂S to the remaining hydrocarbon feedstock is less likely to oxidize the non-alkali metal, including heavy metal. If oxidized non-alkali metal were allowed to dissolve, it could foul the membranes in the electrolytic cell used in the electrolyzing step 227 and prevent or substantially inhibit the recovery of alkali metal in that step. The step 230 of adding at least one of H₂S and H₂O to the remaining hydrocarbon feedstock is substantially the same as step 130 described in conjunction with FIG. 1 above.

The process 200 includes the step of forming 240 at least one of MHS and MOH in the hydrocarbon feedstock. After removing a substantial portion of any non-alkali metal and alkali metal sulfide from the hydrocarbon feedstock and adding one of H₂S and H₂O, the H₂S and/or H₂O react with the remaining alkali metal in the hydrocarbon feedstock to form at least one of MHS and MOH, wherein M is an alkali metal. The step 240 of forming at least one of MHS and MOH in the hydrocarbon feedstock is substantially the same as step 140 described in conjunction with FIG. 1 above.

The process 200 includes the step of separating out 250 at least one of MHS and MOH from the hydrocarbon feedstock. Step 250 may include the step of coalescing 255 the MOH and/or MHS such that the MOH and/or MHS is combined or agglomerated to make it easier to separate it from the hydrocarbon feedstock. Step 250 may also include the step of collecting 257 coalesced MHS and/or MOH. The steps of separating 250, coalescing 255, and collection 257 are substantially the same as steps 150, 155, and 157 described above in conjunction with FIG. 1.

The process 200 includes the step of treating the at least one of MOH and MHS to form at least one of alkali metal sulfide and hydrogen sulfide. In one embodiment, treating 260 the at least one of MOH and MHS comprises combining at least one of the MOH and MHS separated out of the hydrocarbon feedstock with at least one of sulfur and an alkali metal polysulfide to form an alkali metal sulfide. In one embodiment, the addition of sulfur and/or an alkali metal polysulfide causes a reaction to create a lower order alkali metal polysulfide or an alkali metal monosulfide and to form and release hydrogen sulfide.

In another embodiment, treating 260 the at least one of MHS and MOH comprises heating MHS to form alkali metal sulfide and hydrogen sulfide according to the following reaction using sodium as a non-limiting example:

2NaHS→Na2S+H2S (17).

In one embodiment, the MHS may be heated such that the MHS is in liquid form. For NaHS, the heating in step 260 may include heating the NaHS to at least 350° C.

The alkali metal sulfide generated in the treating step 260 may be included in the removing alkali metal form alkali metal sulfide step 220 described above. Removing alkali metal from alkali metal sulfide separated out from the hydrocarbon feedstock includes removing alkali metal from alkali metal sulfide compounds that have been removed from the hydrocarbon feedstock. In other words, separating out alkali metal sulfide from the hydrocarbon feedstock includes separating out MOH or MHS and treating one or both of those to create alkali metal sulfide. The hydrogen sulfide H₂S generated in the treating step 260 may be used during the step of adding at least one of H₂S and H₂O to the remaining hydrocarbon feedstock.

In one embodiment, separating out MHS and/or MOH may include the step of sparging 259 the mixture containing the MHS and/or MOH. The sparging step 259 may occur after the coalescing step 255 and before the collecting step 257. In one embodiment, the sparging step 259 may occur as part of the forming step 240 or just after the adding step 230. In another embodiment, the sparging step 259 may occur after the separating step 250. In the embodiment illustrated in FIG. 2, the hydrocarbon feedstock mixture is allowed to cool. It may then be sparged with a non-oxidizing, dry gas to release dissolved hydrogen sulfide from the liquid hydrocarbon feedstock. The gas may include without limitation, hydrogen, methane, argon, nitrogen, or other non-oxidizing gasses that can strip or dissolve any residual H₂S from the hydrocarbon feedstock. The liquid hydrocarbon feedstock proceeds to the collecting step 257 where MHS and/or MOH is centrifuged or filtered out of the hydrocarbon feedstock.

After the MHS and/or MOH is separated out 250 of the hydrocarbon feedstock, the hydrocarbon feedstock now has reduced sulfur, reduced non-alkali metals including reduces heavy metals, and low alkali metal content. The hydrocarbon feedstock may be washed in a final step (not shown). The washing may result in further reduction of alkali metal content by eliminating any residual alkali metal hydrosulfide not removed in the separating and treating steps 250 and 260.

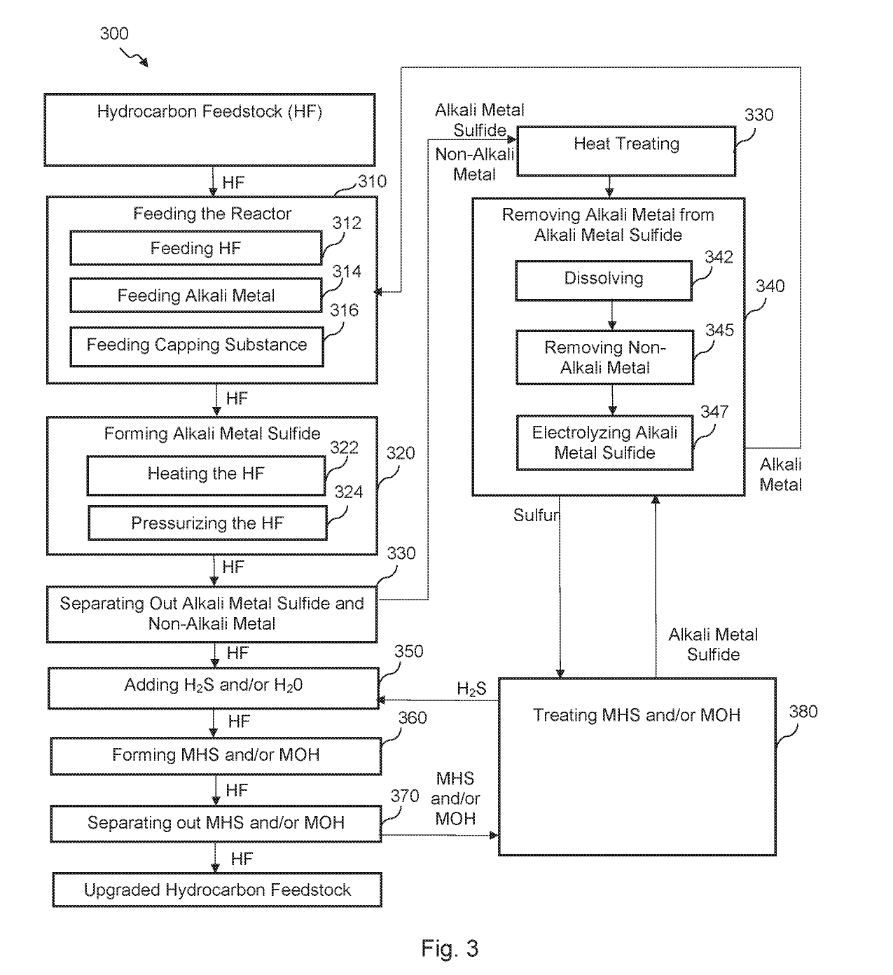

Referring now to FIG. 3, a method 300 of upgrading a hydrocarbon feedstock includes feeding 310 a reactor. The feeding step 310 includes feeding 312 a hydrocarbon feedstock into the reactor, feeding 314 an alkali metal into the reactor, and feeding 316 a radical capping substance into the reactor. As mentioned above, the hydrocarbon feedstock may include any number of hydrocarbon sources, including petroleum distillates, residues, or other petroleum products, shale oil, bitumen, heavy oil, and the like. These hydrocarbon feedstocks may contain high levels of nitrogen, sulfur, and heavy metals which need to be removed or reduced before the hydrocarbon feedstock can be further treated to make a more consumer friendly or commercial product. The radical capping substance may include hydrogen, or compounds that may react with the contents in the reactor to form hydrogen, including without limitation hydrogen sulfide. The alkali metal may include sodium, lithium, sodium alloys, lithium alloys and mixtures thereof.

The method 300 includes forming 320 alkali metal sulfides. The forming step 320 may include heating 322 the hydrocarbon feedstock. In one embodiment, the reactor is heated 322 to a temperature above the melting temperature of the alkali metal fed into the reactor. In the case of sodium, this temperature may be 98° C. In the case of lithium, this temperature may be about 181° C. In another embodiment, the reactor, and thus the hydrocarbon feedstock, may be heated 322 to a temperature ranging from 150° C. to 450° C. In another embodiment, the hydrocarbon feedstock is heated 322 to a temperature ranging from 300° C. to 360° C. The hydrocarbon feedstock may be heated to a temperature that results in faster reaction kinetics but that avoids thermal cracking.

The forming step 320 may also include pressurizing 324 the hydrocarbon feedstock. In one embodiment the reactor, and thus the hydrocarbon feedstock contained therein, is pressurized to a pressure ranging from 500 to 2000 psi. The heating 322 and pressurizing 324 steps may occur simultaneously or one after the other. The forming step and steps 322 and 324 may occur in the reactor of step 310 or in separate reactors.

The method 300 includes the steps of separating out 330 at least a portion of any alkali metal sulfide and any non-alkali metal from the hydrocarbon feedstock. The separating step 330, includes the steps of coalescing (not shown) and collecting (not shown) and are described in detail in conjunction with FIGS. 1 and 2 above. The method 300 also includes the steps of heat treating 330 the alkali metal sulfide and non-alkali metal which is described in detail above in conjunction with step 219 of FIG. 2. The method also includes the step of removing 340 alkali metal from alkali metal sulfide. Step 340 may include the steps of dissolving 342, removing non-alkali metal 345 and electrolyzing 347 alkali metal sulfide. These steps are substantially similar to the corresponding steps 120, 122, 125, 127, 220, 222, 225 and 227 described in conjunction with FIGS. 1 and 2 above. In one embodiment, the alkali metal formed during the electrolyzing step 347 may be recycled back and used in step 314 to feed the reactor.

The method 300 also includes the steps of adding 350 at least one of H₂S and H₂O to the remaining hydrocarbon feedstock and forming 370 at least one of MHS and MOH in the hydrocarbon feedstock. These steps are substantially the same as steps 130 and 140 of FIGS. 1 and 230 and 240 of FIG. 2 and are described in detail above.

The method 300 also includes the steps of separating out 370 at least one of NaOH or MHS from the hydrocarbon feedstock, including the steps of coalescing (not shown) and collecting (not shown). These steps are substantially similar to steps 250, 255, 257 and 257 and are described in detail above. The separated MHS and MOH may be treated in treating step 380 which is also substantially the same as step 260 of method 200 and is described in detail above in conjunction with FIG. 2. The remaining hydrocarbon feedstock is considered upgraded.

It will be appreciated by those of skill in the art that some of the steps within the methods 100, 200 and 300 and the methods 100, 200 and 300 themselves may be run in batch continuous mode. In continuous mode, the upgraded hydrocarbon feedstock may feed back into an original vessel and the process steps repeated to further upgrade the hydrocarbon feedstock, depending upon how much sulfur, nitrogen or non-alkali metal needs to be removed. Indeed steps may be carried out in one or more vessels that may be able to withstand pressure and may include heaters. Steps that involve heating, cooling, coalescing, mixing, pressurizing and the like may be done in the same or separate vessels. For example, the step of adding H₂S and/or H₂0 in step 130 of method 100, and the step of forming 140 MHS and/or MOH may be accomplished in the same vessel. The step of coalescing 155 and collecting 157 may also be accomplished in that same vessel. However, it may be advantageous to operate the first vessel at a lower range and temperature which doesn't required the strength parameters as heating to a higher temperature. In this instance, it may be advantage to then move the hydrocarbon feedstock to another vessel which may be heated to a higher temperature to facilitate coalescing. In the case of NaHS the hydrocarbon feedstock and liquid NaHS may be mixed and heated to coalesce droplets of the NaHS.

Accordingly, the steps of the methods of the present invention may be combined or performed simultaneously or in a variety of orders to achieve their intended purpose.

In one non-limiting example of the method 300 of upgrading a hydrocarbon feedstock, a liquid phase alkali metal is brought into contact with the organic molecules of a hydrocarbon feedstock containing heteroatoms and metals in the presence of hydrogen. The organic molecules may include sulfur, nitrogen and metals. The free energy of reaction with sulfur, nitrogen and metals is stronger with alkali metals than with hydrogen so a reaction more readily occurs without full saturation of the organics with hydrogen. Hydrogen is used in the reaction to cap radicals formed when heteroatoms and metals are removed from the hydrocarbon feedstock. Alkali metal sulfide compounds are formed out of the added alkali metal and the sulfur residing in the hydrocarbon feedstock. Heavy metals may be reduced to the metallic state with the addition of the alkali metal. It is desirous now to remove them from the hydrocarbon feedstock. This is accomplished by coalescing them. The alkali metal sulfide and heavy metals may be heated to a temperature ranging from 350° C. to 400° C. while being mixed for a period of time. The coalesced alkali metal sulfide and heavy metals may be collected by methods such as centrifugation or filtering to separate the organic, upgraded hydrocarbon feedstock, from the solid phase alkali metal sulfide and heavy metal. It may be desirable to rinse the solids with a low viscosity oil to collect any oil adhered to the solids.

Once the alkali metal sulfide and metals have been separated from the oil, sulfur and metals are substantially removed, and nitrogen is moderately removed, also, both viscosity and density are reduced (API gravity is increased). Depending on the nature of the oil, there may be considerable alkali metal content remaining. Sometimes more than 1% by weight, and the alkali metal content is not appreciably in the form of alkali metal sulfide as the alkali metal content far exceeds the amount possible in the form of alkali metal sulfide based on the remaining sulfur content of the oil. Some of the alkali metal content may be associated ionically at the sites where heavy metals originally held position or ionically associated with napthenates, or finely dispersed in the metallic state, or ionically associated with sulfur or nitrogen which is still bonded to the organic molecules of the oil.

To remove this alkali metal content, H₂S and/or H₂O may be added to the remaining hydrocarbon feedstock to form at least one of MHS and MOH. The MHS and/or MOH may be coalesced and collected and then treated to form alkali metal sulfides and H₂S. The alkali metal may be removed from the alkali metal sulfide by the same steps as used above and the H₂S may be reused and added to additional alkali metal content in the hydrocarbon feedstock.

### EXAMPLES OF THE METHODS OF THE PRESENT INVENTION

### Example 1

A mixture of natural gas condensate (diluent) and bitumen also known as dilbit (diluted bitumen) was received. The natural gas condensate (diluent) was evaporated off with vacuum distillation. The remaining bitumen was analyzed and contained 4.72% S, 1.35 ppm Fe, 197 ppm V, and 72.9 ppm Ni and 8.46 ppm Na. The feedstock was then treated with molten sodium in a 1.8 liter autoclave under high pressure H2 gas. Reactor contents were collected as a slurry and centrifuged. The decanted liquid oil contained 0.142% S, 0.08 ppm Fe, 0.669 ppm V, 1.21 ppm Ni and 10860 ppm Na. Thus the sulfur, Fe, V, and Ni content were reduced dramatically by 97.0%, 94.0%, 99.7%, and 98.4% respectively. But the Na increased by 129820%. Thus over 94% of the metals initially contained in the feedstock were removed by the process but the sodium increased tremendously. The molar ratio of the remaining sodium and sulfur was 10.7 to 1 so the remaining sodium could not be in the form of sodium sulfide (Na2S). The decanted alkali treated oil was then placed in another autoclave and contacted with H₂S at above 350° C. for 1 hour. This product was again centrifuged and the decanted liquid analyzed. Values obtained for Na and S respectively were about 0.0018% (18 ppm) and 0.16% by mass, thus the sodium content was dramatically reduced and the sulfur content increased slightly. The solids from the initial sodium metal treatment and the solids from the hydrogen sulfide treatment were thermally treated, the sodium sulfide was dissolved in solvent and electrolyzed without fouling of the electrolytic cell membrane to recover the sodium for reuse in the process.

### Example 2

A petroleum bottoms sample from an ebulatting bed residue hydrocracker (LC Finer Process) was treated with sodium and a 1.8 liter autoclave under high pressure H₂. The bottoms sample and contained 1.99% S, 44.7 ppm Fe, 70.6 ppm V, and 49.4 ppm Ni and 2.42 ppm Na. Sample was collected as slurry and centrifuged. The decanted liquid oil contained 0.074% S, 0.115 ppm Fe, 0.25 ppm V, 0.157 ppm Ni and 5172 ppm Na. Thus the sulfur, Fe, V, and Ni content were reduced dramatically by 96.28%, 99.7%, 99.6%, and 99.7% respectively. But the Na increased by 213707%. Thus over 99% of the metals initially contained in the feedstock where removed by the process but the sodium increased tremendously. The molar ratio of the remaining sodium and sulfur was 9.75 to 1 so the remaining sodium could not be in the form of sodium sulfide (Na₂S). This decanted liquid was returned to an autoclave to reduce the sodium. It was contacted with H₂S at above 350 C for 1 hr. Product was centrifuged and decanted. Values for the “polished” product were 0.0020% (20 ppm) for sodium and 0.15% for sulfur by mass, thus the sodium content was dramatically reduced and the sulfur content increased slightly. The solids from the initial sodium metal treatment and the solids from the hydrogen sulfide treatment were thermally treated, the sodium sulfide was dissolved in solvent and electrolyzed without fouling of the electrolytic cell membrane to recover the sodium for reuse in the process.

### Example 3

A Canadian bitumen vacuum distillation residue sample was treated with sodium and a 1.8 liter autoclave under high pressure H₂. The residue sample and contained 7.27% S, 7.33 ppm Fe, 398 ppm V, and 148 ppm Ni and 11.7 ppm Na. Sample was collected as slurry and centrifuged. The decanted liquid oil contained 0.35% S, 0.181 ppm Fe, 4.47 ppm V, 13.0 ppm Ni and 11920 ppm Na. Thus the sulfur, Fe, V, and Ni content were reduced dramatically by 95.2%, 97.5%, 98.9%, and 91.2% respectively. But the Na increased by 102042%. Thus over 90% of the metals initially contained in the feedstock where removed by the process but the sodium increased tremendously. The molar ratio of the remaining sodium and sulfur was 4.82 to 1 so the remaining sodium could not be in the form of sodium sulfide (Na₂S). This decanted liquid was returned to an autoclave to reduce the sodium. It was contacted with H₂S at above 350 C for 1 hr. Product was centrifuged and decanted. Values for the ‘polished’ product were 0.0040% (40 ppm) for sodium and 0.52% for sulfur by mass, thus the sodium content was dramatically reduced and the sulfur content increased slightly. The solids from the initial sodium metal treatment and the solids from the hydrogen sulfide treatment were thermally treated, the sodium sulfide was dissolved in solvent and electrolyzed without fouling of the electrolytic cell membrane to recover the sodium for reuse in the process.

While specific embodiments of the present invention have been illustrated and described, numerous modifications come to mind without significantly departing from the spirit of the invention, and the scope of protection is only limited by the scope of the accompanying claims.

All the patent applications and patents listed herein are expressly incorporated herein by reference.

What is claimed is:

1. A method for recovering alkali metal from a hydrocarbon feedstock comprising alkali metal sulfide and non-alkali metal, the method comprising:
separating out at least a portion of any alkali metal sulfide and a portion of any non-alkali metal from the hydrocarbon feedstock;
adding at least one of H₂S and H₂O to the remaining hydrocarbon feedstock;
forming at least one of MHS and MOH in the hydrocarbon feedstock, wherein M is an alkali metal;
separating out at least one of MOH and MHS from the hydrocarbon feedstock; and
removing alkali metal from any alkali metal sulfide separated out from the hydrocarbon feedstock.

2. The method of claim 1, wherein the step of separating out at least a portion of any alkali metal sulfide and a portion of any non-alkali metal from the hydrocarbon feedstock comprises coalescing at least a portion of any alkali metal sulfide and a portion of any non-alkali metal.

3. The method of claim 1, wherein the step of separating out at least a portion of any alkali metal sulfide and a portion of any non-alkali metal from the hydrocarbon feedstock comprises separating out greater than about 60% of the non-alkali metal from the hydrocarbon feedstock.

4. The method of claim 3, wherein the step of separating out at least a portion of any alkali metal sulfide and a portion of any non-alkali metal from the hydrocarbon feedstock comprises separating out greater than about 70% of the non-alkali metal from the hydrocarbon feedstock.

5. The method of claim 4, wherein the step of separating out at least a portion of any alkali metal sulfide and a portion of any non-alkali metal from the hydrocarbon feedstock comprises separating out greater than about 80% of the non-alkali metal from the hydrocarbon feedstock.

6. The method of claim 5, wherein the step of separating out at least a portion of any alkali metal sulfide and a portion of any non-alkali metal from the hydrocarbon feedstock comprises separating out greater than about 90% of the non-alkali metal from the hydrocarbon feedstock.

7. The method of claim 6, wherein the step of separating out at least a portion of any alkali metal sulfide and a portion of any non-alkali metal from the hydrocarbon feedstock comprises separating out greater than about 95% of the non-alkali metal from the hydrocarbon feedstock.

8. The method of claim 7, wherein the step of separating out at least a portion of any alkali metal sulfide and a portion of any non-alkali metal from the hydrocarbon feedstock comprises separating out greater than about 98% of the non-alkali metal from the hydrocarbon feedstock.

9. The method of claim 1, wherein the step of separating out at least a portion of any alkali metal sulfide and a portion of any non-alkali metal from the hydrocarbon feedstock comprises separating out greater than about 60% of any alkali metal sulfide from the hydrocarbon feedstock.

10. The method of claim 9, wherein the step of separating out at least a portion of any alkali metal sulfide and a portion of any non-alkali metal from the hydrocarbon feedstock comprises separating out greater than about 70% of any alkali metal sulfide from the hydrocarbon feedstock.

11. The method of claim 10, wherein the step of separating out at least a portion of any alkali metal sulfide and a portion of any non-alkali metal from the hydrocarbon feedstock comprises separating out greater than about 80% of any alkali metal sulfide from the hydrocarbon feedstock.

12. The method of claim 11, wherein the step of separating out at least a portion of any alkali metal sulfide and a portion of any non-alkali metal from the hydrocarbon feedstock comprises separating out greater than about 90% of any alkali metal sulfide from the hydrocarbon feedstock.

13. The method of claim 1, wherein H₂S is added to the hydrocarbon feedstock after a substantial portion of any non-alkali metal has been removed from the hydrocarbon feedstock, and wherein MHS is formed in the hydrocarbon feedstock according to at least one of the following formulas:
M+H₂S→MHS+½H₂ (1)
M⁺+H₂S→MHS+H⁺ (2)
M-salt+H₂S→MHS+H-salt (3)
MNH₂+H₂S→MHS+NH₃ (4),
wherein M represents an alkali metal, M⁺ represents an alkali metal ion, M-salt represents an alkali metal salt and H-salt represents the corresponding acid of the alkali metal salt M-salt.

14. The method of claim 1, wherein H₂O is added to the hydrocarbon feedstock after a substantial portion of any alkali metal sulfide and a substantial portion of any non-alkali metal has been removed from the hydrocarbon feedstock, and wherein NaOH is formed in the hydrocarbon feedstock according to at least one of the following formulas:
M+H₂O→NaOH+½H₂ (5)
M⁺+H₂O→NaOH+H⁺ (6)
M-salt+H₂O→MOH+H-salt (7)
MNH₂+H₂O→MOH+NH₃ (8),
wherein M represents an alkali metal, M⁺ represents an alkali metal ion, M-salt represents an alkali metal salt and H-salt represents the corresponding acid of the alkali metal salt M-salt.

15. The method of claim 1, wherein the step of separating out at least one of MOH or MHS from the hydrocarbon feedstock comprises heating the at least one of MOH and MHS to at least the melting point of one of the MOH and MHS.

16. The method of claim 15, wherein the step of separating out at least one of MOH or MHS from the hydrocarbon feedstock comprises heating the at least one of MOH and MHS to the greater of the melting point of MOH and the melting point of MHS.

17. The method of claim 1, wherein the step of separating out at least one of MOH and MHS from the hydrocarbon feedstock comprises cooling the at least one of MOH and MHS to form at least one of a MOH or MHS in solid form.

18. The method of claim 1, further comprising treating the at least one of MOH and MHS to form at least one of alkali metal sulfide and hydrogen sulfide.

19. The method of claim 18, further comprising using any hydrogen sulfide, formed during the step of treating the at least one of MOH and MHS, in the step of adding at least one of H₂S and H₂O to the remaining hydrocarbon feedstock.

20. The method of claim 1, wherein the step of removing alkali metal from alkali metal sulfide comprises dissolving the alkali metal sulfide in a solution comprising a polar solvent.

21. The method of claim 20, wherein the step of removing alkali metal from alkali metal sulfide further comprises removing a substantial amount of non-alkali metal from the solution.

22. The method of claim 21, wherein the step of removing alkali metal from alkali metal sulfide further comprises electrolyzing the solution after non-alkali metal has been substantially removed from the solution to create alkali metal.

23. A method of upgrading a hydrocarbon feedstock comprising non-alkali metal and sulfur, the method comprising:
feeding a hydrocarbon feedstock into a reactor;
feeding a radical capping substance into the reactor;
feeding an alkali metal into the reactor;
forming alkali metal sulfide in the hydrocarbon feedstock;
separating out at least a portion of any alkali metal sulfide and a portion of any non-alkali metal from the hydrocarbon feedstock;
adding at least one of H₂S and H₂O to the remaining hydrocarbon feedstock;
forming at least one of MHS and MOH in the hydrocarbon feedstock;
separating out at least one of MOH or MHS from the hydrocarbon feedstock; and
removing alkali metal from any alkali metal sulfide separated out from the hydrocarbon feedstock.

24. The method of claim 23, further comprising treating at least one of MOH or MHS separated out from the hydrocarbon feedstock to form at least an alkali metal sulfide.

25. The method of claim 24, wherein the step of removing alkali metal from any alkali metal sulfide separated out from the hydrocarbon feedstock includes removing alkali metal from alkali metal sulfide formed in the step of treating at least one of MOH or MHS separated out from the hydrocarbon feedstock to form at least an alkali metal sulfide.
